(19) United States
(12) Patent Application Publication
(10) Pub. No.: US 2010/0024909 A1
(43) Pub. Date: Feb. 4, 2010

(54) ADJUSTABLE ROD STRUCTURE

(76) Inventors: Zhong Ping LU, Xiamen (CN); Qing Sen LU, Xiazai Town (CN); Hui CHEN, Xingcun Town (CN)

Correspondence Address: Dr. BANGER SHIA, 102 Lindencrest Ct., Sugar Land, TX, 77479-5201, US

(21) Appl. No.: 12/512,165

(22) Filed: Jul. 30, 2009

(30) Foreign Application Priority Data
Jul. 30, 2008 (CN) 200820103272.4
Apr. 21, 2009 (CN) 200920137854.9

(51) Int. Cl. F16K 11/00

(52) U.S. Cl. 137/861

(57) ABSTRACT

An adjustable rod structure includes a rod and a connecting device disposed at an upper end of the rod for connecting with a shower head and a water supply pipe. The connecting device is movably connected to the water supply pipe. A lower end of the rod is secured to a wall via a retaining unit. The retaining unit is movably connected to the rod. The rod is provided with a water valve to control water flowing through a spray nozzle or the shower head selectively. The adjustable rod structure is adjusted to comply with a different distance from the water supply pipe to the wall. The installed position of the adjustable rod structure is more flexible, and the retaining disc is fixed on the wall firmly. The adjustable rod structure is able to be installed, without drilling holes on the wall. This prevents the wall from being damaged.

### BACKGROUND OF THE INVENTION

1. Field of the Invention

The present invention relates to a shower bath appliance, and more particularly to an adjustable rod structure.

2. Description of the Prior Art

There are two ways to install a shower head. On type is immovable, which is adopted in an inn or apartment. The position of the shower head is fixed. The user has to stand at a limited area for taking a shower bath.

The other type is movable, which is generally adapted for domestic use. The shower head is connected to a hose for supplying water, which is named a spray nozzle. The position of usage is movable. The spray nozzle may be held by hand or secured on a retaining bracket disposed on the wall.

For the flexibility of the shower head, the shower head may be mounted with an adjustable rod to control its height. The adjustable rod is provided with a retaining bracket to position the spray nozzle for adjusting the angle of spraying.

To comply with the demands for the flexibility of the shower head, the water supply pipe on the wall is formed with two water ways. One is connected with the hose which is connected with the spray nozzle, and the other is connected with the shower head fixed on the wall. A three-way water valve is provided at the mouth of the water supply pipe for controlling the water to come out through the spray nozzle or through the shower head. In some countries, such as America, the mounting position of a water supply pipe is restricted. The wall-mount water supply pipe is connected with the shower head. It is necessary to provide a water valve at the mouth of the water supply pipe to form a branch water way for connecting with the spray nozzle. However, the height of the user must be tall enough to adjust the water valve. For a user who is not tall enough or a child, they are unable to make an adjustment.

In general, the adjustable rod is fixed on the wall with screws inserting through holes of retaining brackets provided at upper and lower ends of the adjustable rod and into the drilled holes of the wall. It is required to drill holes on the wall for fixing the adjustable rod. Though drilling is not difficult, the user has to use a special tool. This is not convenient for the user to install the adjustable rod.

Furthermore, the water supply pipe is provided at the upper portion of the wall. To fix up a building, there may be a difference of the exposed length of the water supply pipe. When the upper end of the adjustable rod is installed on the wall and a connecting rod in a specific length is connected with the adjustable rod, the distance from the lower end of the adjustable rod to the wall may be changed. This causes the installation of the adjustable rod is not firm. Sometimes, the installation cannot be achieved.

Accordingly, the inventor of the present invention has devoted himself based on his many years of practical experiences to solve this problem.

### SUMMARY OF THE INVENTION

The primary object of the present invention is to provide an adjustable rod structure, which is convenient for installation and adapted to connect with the existing water supply pipe, without drilling holes on the wall.

Another object of the present invention is to provide an adjustable rod structure, which is controllable to switch the water flowing out through the spray nozzle or through the shower head.

According to the present invention, there is provided an adjustable rod structure, comprising a rod and a connecting device disposed at an upper end of the rod for connecting with a shower head and a water supply pipe, the connecting device being movably connected to the water supply pipe, a lower end of the rod being secured to a wall via a retaining unit, the retaining unit being movably connected to the rod, the rod being provided with a water valve to control water flowing through a spray nozzle or the shower head.

Preferably, the retaining unit is provided with a retaining disc or glue for connecting with the wall.

Preferably, the connecting device is connected to the water supply with a universal joint, and the retaining unit is connected to the rod with a universal joint.

Preferably, the connecting device is connected to the water supply with a pin, and the retaining unit is connected to the rod with a pin.

Preferably, the rod has a lower end provided with a water valve.

Preferably, the rod has two separate channels therein and the connecting device has a three-way T-shaped body having two ends formed with outer threads, one end being a first inlet to connect with the water supply pipe, the other end being a first outlet to connect with the shower head, the connecting device having a lower end formed with a second inlet and a second outlet to connect with the two separate channels in the rod, the connecting device having an inlet channel defined between the first inlet and the second inlet and an outlet channel defined between the second outlet and the first outlet.

Preferably, the lower end of the rod is connected with the water valve, the water valve has a third inlet and a third outlet to connect with the two separate channels in the rod respectively, and a fourth outlet to connect with a hose which is connected with the spray nozzle.

Preferably, the water valve is integrally formed with the retaining unit, the water valve comprising a valve base, a valve core and a knob, the valve base having an upper end formed the third inlet and the third outlet for interconnecting with lower ends of the two separate channels of the rod respectively, the valve base having a lower end formed with the fourth outlet to connect with the hose which is connected with the spray nozzle, the knob being disposed at one side of the valve base and connected with the valve core of the valve base, the valve base having another side secured to a sucking disc.

Alternatively, the water valve and the retaining unit are formed separately.

Alternatively, the connecting device is provided with a water valve.

Preferably, the connecting device has a three-way T-shaped body having two ends formed with outer threads, one end being a first inlet to connect with the water supply pipe, the other end being a first outlet to connect with the shower head, the connecting device having a lower end formed with a second outlet to connect with the rod.

The upper and lower ends of the adjustable rod structure are connected in a movable way, such that the adjustable rod structure is adjusted to comply with a different distance from the water supply pipe to the wall. The installed position of the adjustable rod structure is more flexible, and the retaining disc is fixed on the wall firmly. No matter how long the distance form the water supply pipe to the wall is (80 mm-200 mm), the adjustable rod structure of the present invention is able to be installed, without drilling holes on the wall. This prevents the wall from being damaged. The upper end of the rod is connected to the existing water supply, and the lower end of the rod is connected to the retaining unit to be fixed on the wall. Therefore, the adjustable rod of the present invention is convenient for installation.

In addition, the upper end of the rod is connected with the connecting device and the rod has two separate water channels therein, providing a switch function for using the spray nozzle or the shower head. This configuration of the present invention is convenient for the user in any height to use and adjust the rod.

### BRIEF DESCRIPTION OF THE DRAWINGS

FIG. 1 is an exploded view according to a first embodiment of the present invention;

FIG. 2 is an assembled front view according to the first embodiment of the present invention;

FIG. 3 is a schematic view in an installed status according to the first embodiment of the present invention;

FIG. 4 is a schematic view according to a second embodiment of the present invention;

FIG. 5 is a schematic view according to a third embodiment of the present invention;

FIG. 6 is a schematic view according to a fourth embodiment of the present invention; and

FIG. 7 is a schematic view according to a fifth embodiment of the present invention.

### DETAILED DESCRIPTION OF THE PREFERRED EMBODIMENTS

Embodiments of the present invention will now be described, by way of example only, with reference to the accompanying drawings.

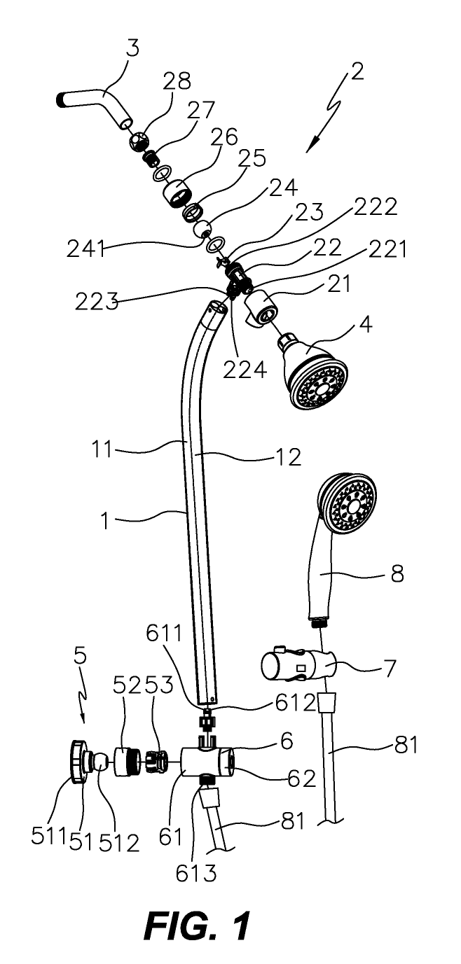

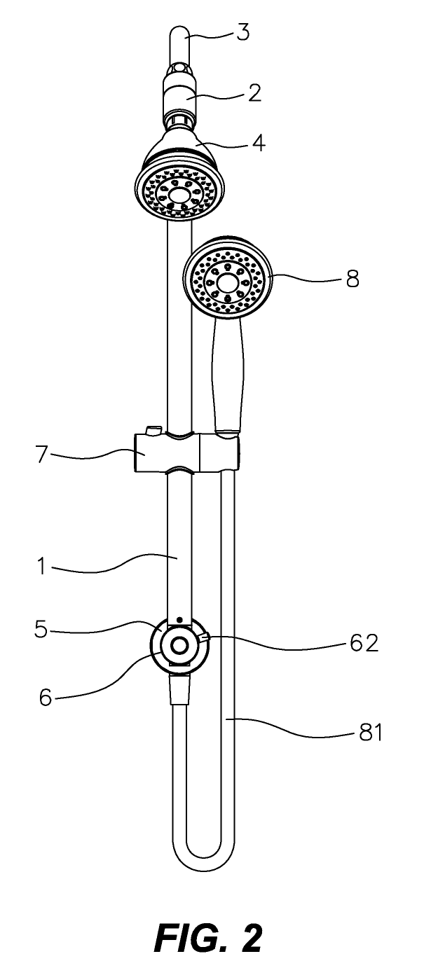

As shown in FIGS. 1 to 3, an adjustable rod structure according to a first embodiment of the present invention comprises a rod 1, a connecting device 2 disposed at the top of the rod 1, a water supply pipe 3 connected to a first end of the connecting device 2, a shower head 4 connected to a second end of the connecting device 2, a retaining unit which is provided with a retaining disc 5 or glue for connecting with the wall, a water valve 6 disposed at a lower end of the rod 6, a retaining seat 7 disposed on the rod 1, and a spray nozzle 8 which is movably connected to the retaining seat 7. The water valve 6 is integrally formed with the retaining unit.

The connecting device 2 is movably connected to the water supply pipe 3, which is a universal joint in this embodiment. The retaining unit is movably connected to the rod 1, which is a universal joint in this embodiment. These two universal joints are adapted for providing a distance adjustment function. The connecting way may be a thread connection, a screw connection, a retaining pin, or the like. In this embodiment, the connecting way is a thread connection as an example.

The rod 1 is a hollow rod having two separate channels therein. In this embodiment, the rod 1 has two water tubes 11, 12 therein.

The connecting device 2 comprises an outer shell 21, a three-way connecting seat 22, a locking lid 23, a ball head 24, a ball sleeve 25, a nut 26, a connecting head 27, and a fastening nut 28.

The outer shell 21 is shaped to accommodate the three-way connecting seat 22 therein.

The three-way connecting seat 22 has a T-shaped body having outer threads at two ends thereof. The three-way connecting seat 22 is secured in the outer shell 21 with the locking lid 23. The two ends having the outer threads of the three-way connecting seat 22 are extended out the outer shell 21. There are two separate channels in the three-way connecting seat 22, namely, a first outlet 221 at the right side, a first inlet 222 at the left side, a second inlet 223 and a second outlet 224 formed at a lower end of the three-way connecting seat 22. The first inlet 222 and the second inlet 223 are adapted to form an inlet channel, while the second outlet 224 and the first outlet 221 are adapted to form an outlet channel. The second inlet 223 and the second outlet 224 at the lower end of the three-way connecting seat 22 are connected with upper ends of the two water tubes 11, 12, respectively.

The ball head 24 is formed with a through hole 241 therein. One side of the nut 26 covers the ball sleeve 25, the ball head 24, and a seal member and is screwed to the three-way connecting seat 22, while the other side of the nut 26 is screwed to the fastening nut 28 through the connecting head 27 and secured to the water supply pipe 3. The shower head 4 is screwed to the three-way connecting seat 22. The lower end of the three-way connecting seat 22 is connected with the rod 1. Thus, a universal joint is formed between the upper end of the rod 1 and the water supply pipe 3 for adjusting the rod 1 in a desired direction with respect to the water supply pipe 3.

The retaining disc 5 comprises a sucking disc assembly 51, a fastening nut 52, and a ball sleeve 53. The sucking disc assembly 51 includes a sucking disc 511 at a rear part thereof and a ball head 512 protruding from a front part thereof. The fastening nut 52 is adapted to cover the ball head 512. The water valve 61 has a valve base 61. One side of the valve base 61 is to secure the ball sleeve 53 for the valve base 61 to be integrally formed with the retaining disc 5, such that the lower end of the rod 1 is adjustable in a desired direction with respect to the wall.

The water valve 6 comprises the valve base 61, a valve core disposed at another side of the valve base 61 (not shown in the drawings), and a knob 62. The valve base 61 has a water divide seat at the top of the valve base 61. The water divide seat is interconnected with the valve base 61. The water divide seat has a third inlet 611 and a third outlet 612 for interconnecting with lower ends of the two water tubes 11, 12 of the rod 1, respectively. The valve base 61 is formed with a fourth outlet 613 at a lower end thereof. The fourth outlet 613 is connected with a hose 81 which is connected with the spray nozzle 8. The knob 62 is disposed at one side of the valve base 61 and connected with the valve core of the valve base 61. The knob 62 is turned to control the communication of the third inlet 611 and the third outlet 612 or the communication of the third inlet 611 and the fourth outlet 613.

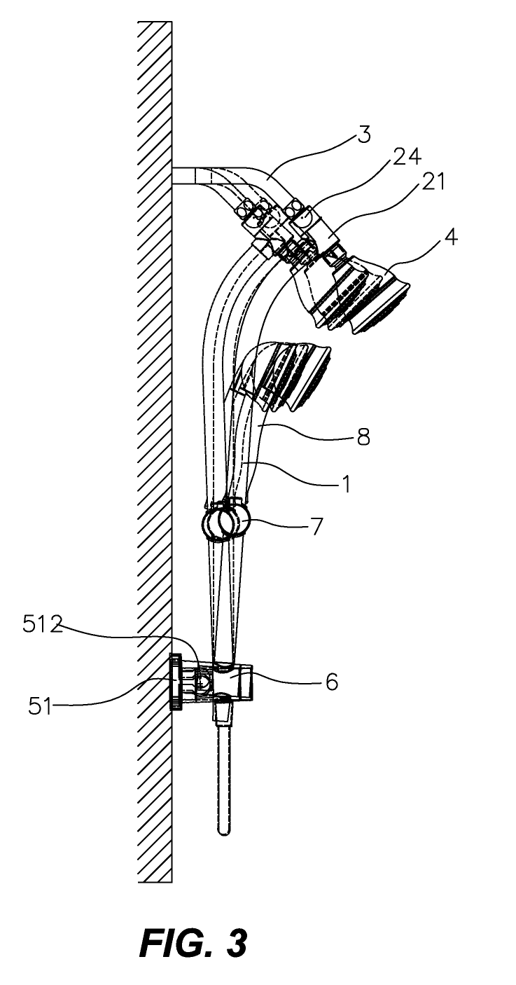

As shown in FIG. 3, the adjustable rod of the present invention is installed on a wall. When the distance from the water supply pipe 3 to the wall is too short, the length of the rod 1 is also too short after the top of the rod 1 is installed. For the distance from the lower end of the rod 1 to the wall, the angle between the rod 1 and the water supply pipe 3 is adjusted to be larger and the angle between the retaining disc 5 and the water valve 6 is adjusted to be smaller, so that the rod 1 is able to be installed on the wall with ease. On the contrary, when the distance from the water supply pipe 3 to the wall is too long, the length of the rod 1 is also too long after the top of the rod 1 is installed. For the distance from the lower end of the rod 1 to the wall, the angle between the rod 1 and the water supply pipe 3 is adjusted to be smaller and the angle between the retaining disc 5 and the water valve 6 is adjusted to be larger, so that the rod 1 is able to be installed on the wall with ease.

When the user wants to use the shower head 4, the knob 62 of the water valve 6 is turned to drive the valve core to turn with respect to the valve base 61 such that the third inlet 611 and the third outlet 612 of the water valve 6 are interconnected. The water flows out through the shower head 4 via the inlet channel of the three-way connecting seat 22, the water tube 11 of the rod 1, the water valve 6, the water tube 12 of the rod 1, and the outlet channel of the three-way connecting seat 22. On the contrary, when the user wants to use the spray nozzle 8, the knob 62 of the water valve 6 is turned to drive the valve core to turn with respect to the valve base 61 such that the third inlet 611 and the fourth outlet 613 of the water valve 6 are interconnected. The water flows out through the spray nozzle 8 via the inlet channel of the three-way connecting seat 22, the water tube 11 of the rod 1, the water valve 6, and the hose 81.

Accordingly, the rod 1 has two universal joints at the upper and lower ends thereof so that the rod 1 is adjustable for a different distance from the water supply pipe 3 to the wall. The retaining disc 5 is secured to the wall firmly. The rod 1 is installed with ease.

In addition, the water valve 6 is located underneath the rod 1, which is convenient for the user to use and make an adjustment. The rod 1 is installed without drilling holes, preventing the wall from being damaged.

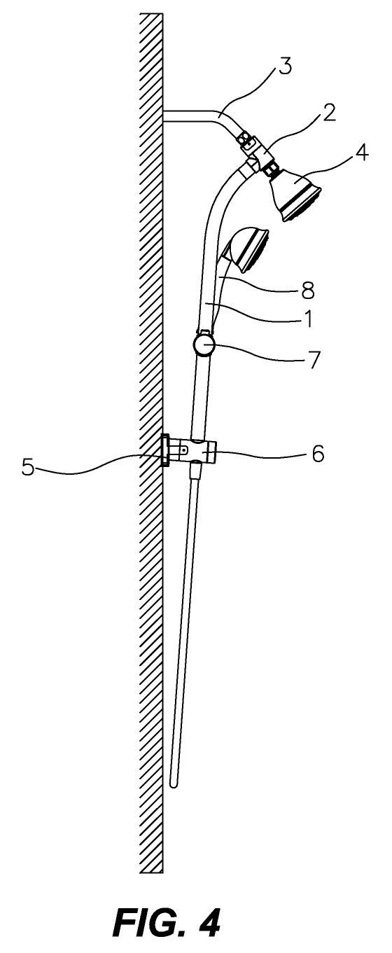

As shown in FIG. 4, an adjustable rod structure according to a second embodiment of the present invention is substantially similar to the first embodiment with the exceptions described hereinafter. The connecting device 2 is connected to the water supply pipe 3 via a retaining pin, while the retaining unit is connected to the rod 1 via another retaining pin. These two retaining pins also have the same function for the rod 1 to be adjusted with respect to the distance from the water supply pipe 3 to the wall.

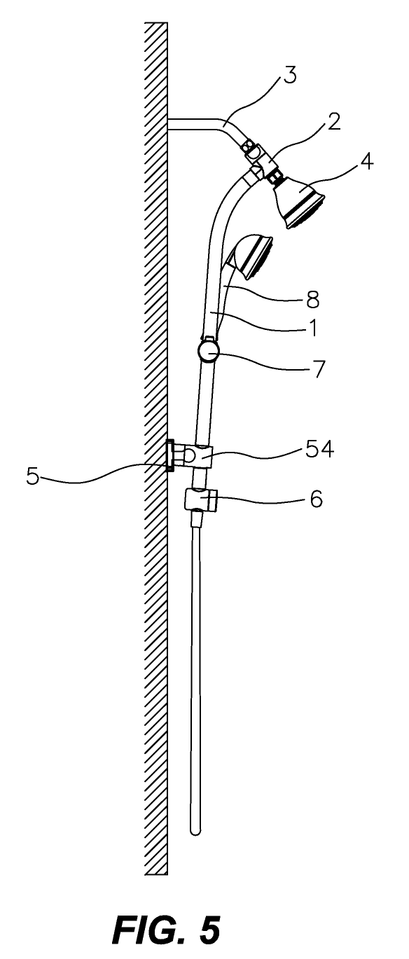

As shown in FIG. 5, an adjustable rod structure according to a third embodiment of the present invention is substantially similar to the first embodiment with the exceptions described hereinafter. The water valve 6 and the retaining unit are formed separately. The retaining unit, for example, the retaining disc has a body 54 connected with the lower end of the rod 1. The water valve 6 is disposed under the body 54 of the retaining disc 5. The adjustable rod structure of the present invention is installed without drilling holes, and is controllable for the water to flow out through the spray nozzle 8 or through the shower head 4.

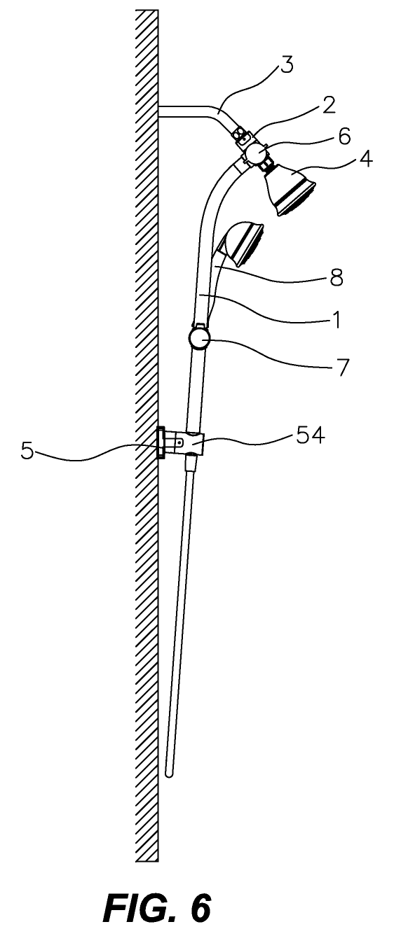

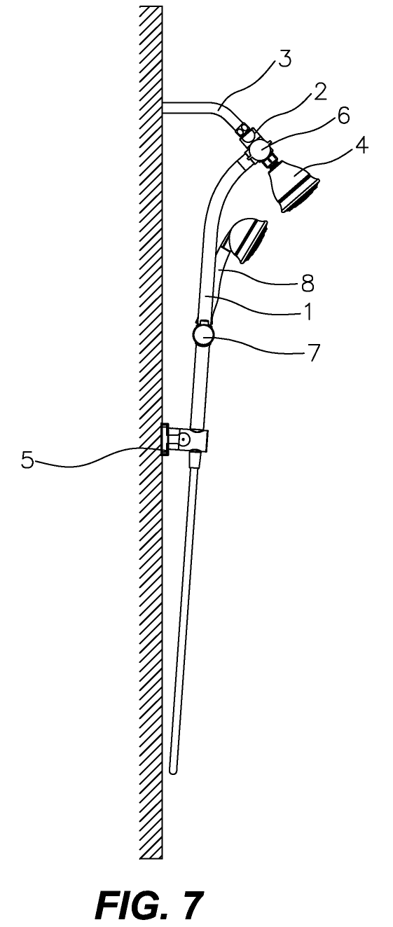

FIGS. 6 and 7 show a fourth embodiment and a fifth embodiment of the present invention. In the fourth embodiment, the connecting device 2 is connected to the water supply pipe 3 via a retaining pin, while the retaining unit is connected to the rod 1 via another retaining pin. In the fifth embodiment, the connecting device 2 is connected to the water supply pipe 3 via a universal ball joint, while the retaining unit is connected to the rod 1 via another universal ball joint. In the fourth and fifth embodiments, the water valve is disposed at the connecting device 2. There is no need for the rod 1 to have two tubes therein. These two embodiments are capable of switching the water to flow through the shower head 4 or through the spray nozzle 8, but the height of the user is limited.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An adjustable rod structure, comprising a rod and a connecting device disposed at an upper end of the rod for connecting with a shower head and a water supply pipe, the connecting device being movably connected to the water supply pipe, a lower end of the rod being secured to a wall via a retaining unit, the retaining unit being movably connected to the rod, the rod being provided with a water valve to control water flowing through a spray nozzle or the shower head.

2. The adjustable rod structure as claimed in claim 1, wherein the retaining unit is provided with a retaining disc or glue for connecting with the wall.

3. The adjustable rod structure as claimed in claim 1, wherein the connecting device is connected to the water supply with a universal joint, and the retaining unit is connected to the rod with a universal joint.

4. The adjustable rod structure as claimed in claim 1, wherein the connecting device is connected to the water supply with a pin, and the retaining unit is connected to the rod with a pin.

5. The adjustable rod structure as claimed in claim 1, 3 or 4, wherein the rod has a lower end provided with a water valve.

6. The adjustable rod structure as claimed in claim 5, wherein the rod has two separate channels therein and the connecting device has a three-way T-shaped body having two ends formed with outer threads, one end being a first inlet to connect with the water supply pipe, the other end being a first outlet to connect with the shower head, the connecting device having a lower end formed with a second inlet and a second outlet to connect with the two separate channels in the rod, the connecting device having an inlet channel defined between the first inlet and the second inlet and an outlet channel defined between the second outlet and the first outlet.

7. The adjustable rod structure as claimed in claim 6, wherein the lower end of the rod is connected with the water valve, the water valve has a third inlet and a third outlet to connect with the two separate channels in the rod respectively, and a fourth outlet to connect with a hose which is connected with the spray nozzle.

8. The adjustable rod structure as claimed in claim 6, wherein the water valve is integrally formed with the retaining unit, the water valve comprising a valve base, a valve core and a knob, the valve base having an upper end formed the third inlet and the third outlet for interconnecting with lower ends of the two separate channels of the rod respectively, the valve base having a lower end formed with the fourth outlet to connect with the hose which is connected with the spray nozzle, the knob being disposed at one side of the valve base and connected with the valve core of the valve base, the valve base having another side secured to a sucking disc.

9. The adjustable rod structure as claimed in claim 1, wherein the water valve and the retaining unit are formed separately.

10. The adjustable rod structure as claimed in claim 1, 3, 4, wherein the connecting device is provided with a water valve.

11. The adjustable rod structure as claimed in claim 10, wherein the connecting device has a three-way T-shaped body having two ends formed with outer threads, one end being a first inlet to connect with the water supply pipe, the other end being a first outlet to connect with the shower head, the connecting device having a lower end formed with a second outlet to connect with the rod.
